(19) United States
(12) Patent Application Publication
(10) Pub. No.: US 2004/0121690 A1
(43) Pub. Date: Jun. 24, 2004

(54) Elastomeric laminates having random copolymer facings

(76) Inventors: Mark Michael Mleziva, Appleton, WI (US); James Russell Fitts JR., Gainesville, GA (US); Leslie D. Dobbins, Marietta, GA (US)

Correspondence Address: PAULEY PETERSEN KINNE & ERICKSON, 2800 WEST HIGGINS ROAD, SUITE 365, HOFFMAN ESTATES, IL, 60195, US

(21) Appl. No.: 10/328,866

(22) Filed: Dec. 23, 2002

(51) Int. Cl. B32B 5/26; B32B 27/00; B32B 27/12

(52) U.S. Cl. 442/381; 442/328; 442/382; 442/389; 442/394

(57) ABSTRACT

An elastomeric laminate that includes at least one facing layer laminated to an elastomeric layer. The facing layer or layers may be nonwoven web(s) made up of thermoplastic filaments formed from a random copolymer or a random copolymer blend. The invention further includes an ultrasonically bonded seam formed by ultrasonically bonding the elastomeric laminate to a substrate, and the method therefor.

### TECHNICAL FIELD OF THE INVENTION

This invention is directed to elastomeric laminates having significant softness and high speed ultrasonic bonding capabilities, and a method of making such elastomeric laminates.

### BACKGROUND OF THE INVENTION

Elastomeric materials are often laminated to a facing material to provide a laminate having elastomeric properties with a more aesthetically pleasing feel than the elastomeric material itself. For example, elastomeric materials may exhibit a rubbery hand, while facing materials may provide a more cloth-like feel. Such laminates can be relatively expensive to manufacture due to the combined cost of the elastomeric material and the facing material. More specifically, the laminate must have a high enough basis weight or stiffness to be manageable, yet must also possess a desired amount of stretchability. The elastomeric materials are typically more expensive than the facing materials.

The facing material, while it may provide a more pleasing feel than the elastomeric material, may still be rough or may be too thin to provide any substantial feelings of softness. Furthermore, if the overall laminate is too thin, the laminate may be porous and/or transparent, which may be inappropriate or unsuitable for use in apparel.

Side panels in disposable absorbent garments are often made up of an elastomeric laminate. However, one drawback often associated with the use of elastomeric laminates in side panels is the consequent side panel tear vulnerability that often results when high speed ultrasonic bonding is used to bond elastomeric laminates. More particularly, high speed ultrasonic bonding may create side seams having a low bond strength due to limited ultrasonic dwell time. Side seam strength is an important attribute of a disposable absorbent garment. High strength side seams provide durability and prevent breaks during pant application and while the garment is worn.

The use of random copolymers as an additive or as a base resin is known to provide thermal calender bonding improvements in such applications as heavyweight spunbond-meltblown-spunbond gowns, as well as in point unbonded loop materials such as those which may be used in hook and loop fasteners.

There is thus a need or desire for elastomeric laminates having facings that provide softer hand and improved ultrasonic bonding performance at a reduced cost without sacrificing stretchability or softness.

### SUMMARY OF THE INVENTION

In response to the discussed difficulties and problems encountered in the prior art, elastomeric laminates having random copolymer facings, and a method of making such elastomeric laminates, have been discovered.

The present invention is directed to a soft, durable elastomeric laminate that is compatible with ultrasonic bonding at commercial line speeds. The laminate includes one or more polymeric facing layers laminated to an elastomeric layer. The facing layer is a nonwoven web made up of thermoplastic filaments formed from a random copolymer, or a random copolymer blend. The copolymer from which the facing layer is made suitably has a peak melting point between about 137 and about 153 degrees Celsius. The facing layer has a basis weight of less than about 20 grams per square meter (gsm), while the elastomeric layer has a basis weight of less than about 18 gsm. Basis weights of facing materials disclosed herein are directed to the unretracted state of the material prior to any gathering. Basis weights of elastic materials disclosed herein can be measured by measuring the relaxed or unstretched basis weight of the elastic component (separated from the laminate) and then dividing that number by the laminate's stretch-to-stop elongation expressed as a percentage of the laminate's initial length, as explained in further detail in U.S. Pat. No. 5,336,793 issued to Fitts, Jr. et al., herein incorporated by reference.

The copolymer from which the facing layer is made may be an ethylene-propylene random copolymer containing, for example, from about 0.5 percent to about 10 percent, by weight, ethylene, and from about 99.5 to about 90 percent, by weight, propylene. Alternatively, the copolymer may be a butylene-propylene random copolymer containing, for example, from about 0.5 percent to about 20 percent, by weight, butylene, and from about 99.5 to about 80 percent, by weight, propylene. The random copolymer provides exceptional softness as well as improved bonding capabilities.

In addition to the choice of copolymer, the basis weight and the bond pattern of the nonwoven facing layer can also be tailored to enhance the functionality of the facing layer.

A bond pattern on the nonwoven0 facing further influences the properties of the laminate. Suitably, the nonwoven facing layer has a bond area of between about 15% and about 34%. Lower cost and higher tension may be achieved through the application of a bond pattern, however softness may be compromised if the bond pattern takes up too much area.

The elastomeric laminate may be a stretch-bonded laminate or a necked-bonded laminate, for example. The laminating process may be carried out using either a continuous vertical filament lamination process or a conventional horizontal lamination process.

Because of the random copolymer composition of the nonwoven facing layer, the elastomeric laminate is conducive to ultrasonic bonding. The elastomeric laminate can be ultrasonically bonded to a substrate, which may be either the same elastomeric laminate material or a different material, at a speed of at least 300 feet per minute, thus forming a seam having a bond strength of about 1 to about 10 kilograms.

The elastomeric laminate of the invention is particularly suitable for use in disposable absorbent garments. More particularly, in pant-like garments such as training pants, the elastomeric laminate is particularly suitable for making side panels. Side seams formed by ultrasonically bonding together two pieces of the elastomeric laminate have exceptional tear strength.

With the foregoing in mind, particular embodiments of the invention provide a soft, elastomeric laminate that is conducive to ultrasonic bonding, and a method of making such an elastomeric laminate.

### BRIEF DESCRIPTION OF THE DRAWINGS

FIG. 1 is a plan view of an elastomeric laminate of the invention.

FIG. 2 is a cross-sectional view of an elastomeric laminate, taken along line 2-2 in FIG. 1.

FIG. 3 schematically illustrates a process that can be used to form the elastomeric laminate of the invention.

FIG. 4 schematically illustrates a continuous vertical filament lamination process that can be used to form the elastomeric laminate of the invention.

FIG. 5 illustrates a side perspective view of a disposable absorbent pant.

FIG. 6 is a graphical representation of the melt characteristics of various facing materials.

### DEFINITIONS

Within the context of this specification, each term or phrase below will include the following meaning or meanings.

“Autogenously bonded” or “autogenously laminated” refers to bonding that occurs between two or more layers by virtue of the properties within one or more layers, such that bonding can be carried out without the use of any externally applied bonding mechanisms such as adhesive, thermal, or ultrasonic mechanisms.

“Bonded carded web” refers to webs that are made from staple fibers which are sent through a combing or carding unit, which separates or breaks apart and aligns the staple fibers in the machine direction to form a generally machine direction-oriented fibrous nonwoven web. Such fibers are usually purchased in bales which are placed in an opener/blender or picker which separates the fibers prior to the carding unit. Once the web is formed, it then is bonded by one or more of several known bonding methods. One such bonding method is powder bonding, wherein a powdered adhesive is distributed through the web and then activated, usually by heating the web and adhesive with hot air. Another suitable bonding method is pattern bonding, wherein heated calender rolls or ultrasonic bonding equipment are used to bond the fibers together, usually in a localized bond pattern, though the web can be bonded across its entire surface if so desired. Another suitable and well known bonding method, particularly when using bicomponent staple fibers, is through-air bonding.

“Bonded” and “bonding” refer to the joining, adhering, connecting, attaching, or the like, of two elements. Two elements will be considered to be bonded together when they are bonded directly to one another or indirectly to one another, such as when each is directly bonded to intermediate elements.

“Coform material” generally refers to composite materials comprising a mixture or stabilized matrix of thermoplastic fibers and a second non-thermoplastic material. As an example, coform materials may be made by a process in which at least one meltblown die head is arranged near a chute through which other materials are added to the web while it is forming. Such other materials may include, but are not limited to, fibrous organic materials such as woody or non-woody pulp such as cotton, rayon, recycled paper, pulp fluff and also superabsorbent particles, inorganic absorbent materials, treated polymeric staple fibers and the like. Any of a variety of synthetic polymers may be utilized as the melt-spun component of the coform material. For instance, in some embodiments, thermoplastic polymers can be utilized. Some examples of suitable thermoplastics that can be utilized include polyolefins, such as polyethylene, polypropylene, polybutylene and the like; polyamides; and polyesters. In one embodiment, the thermoplastic polymer is polypropylene. Some examples of such coform materials are disclosed in U.S. Pat. Nos. 4,100,324 to Anderson, et al.; 5,284,703 to Everhart, et al.; and 5,350,624 to Georger, et al.; which are incorporated herein in their entirety by reference thereto for all purposes. “Elastomeric” or “elastic” refers to a material or composite which can be elongated by at least 25 percent of its relaxed length and which will recover, upon release of the applied force, at least 10 percent of its elongation. It is generally preferred that the elastomeric material or composite be capable of being elongated by at least 100 percent, more preferably by at least 300 percent, of its relaxed length and recover, upon release of an applied force, at least 50 percent of its elongation.

“Film” refers to a thermoplastic film made using a film extrusion and/or forming process, such as a cast film or blown film extrusion process. The term includes apertured films, slit films, and other porous films which constitute liquid transfer films, as well as films which do not transfer liquid.

“Garment” includes pant-like absorbent garments and medical and industrial protective garments. The term “pant-like absorbent garment” includes without limitation diapers, training pants, swim wear, absorbent underpants, baby wipes, adult incontinence products, and feminine hygiene products. The term “medical protective garment” includes without limitation surgical garments, gowns, aprons, face masks, and drapes. The term “industrial protective garment” includes without limitation protective uniforms and workwear.

“Machine direction” as applied to a film or web, refers to the direction on the film or web that was parallel to the direction of travel of the film or web as it left the extrusion or forming apparatus. If the film or web passed between nip rollers or chill rollers, for instance, the machine direction is the direction on the film or web that was parallel to the surface movement of the rollers when in contact with the film or web. “Cross direction” and “cross-machine direction,” used interchangeably, refer to the direction perpendicular to the machine direction. Dimensions measured in the cross direction are referred to as “width” dimensions, while dimensions measured in the machine direction are referred to as “length” dimensions.

“Meltblown fibers” are fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. No. 3,849,241 to Butin et al. Meltblown fibers are microfibers which may be continuous or discontinuous, are generally smaller than about 1.0 denier, and are generally self bonding when deposited onto a collecting surface.

“Neck” or “neck stretch” interchangeably mean that the fabric, nonwoven web or laminate is drawn such that it is extended under conditions reducing its width or its transverse dimension by stretching lengthwise or increasing the length of the fabric. The controlled drawing may take place under cool temperatures, room temperature or greater temperatures and is limited to an increase in overall dimension in the direction being drawn up to the elongation required to break the fabric, nonwoven web or laminate, which in most cases is about 1.2 to 1.6 times. When relaxed, the fabric, nonwoven web or laminate does not return totally to its original dimensions. The resulting neck-stretched fabric can be extended in the lateral (cross-machine) direction of the fabric during subsequent use, causing the fabric to return toward its original pre-necked configuration. The necking process typically involves unwinding a sheet from a supply roll and passing it through a brake nip roll assembly driven at a given linear speed. A take-up roll or nip, operating at a linear speed higher than the brake nip roll, draws the fabric and generates the tension needed to elongate and neck the fabric. Such neck-stretching processes are disclosed, for example, in U.S. Pat. No. 4,443,513 to Meitner et al.; U.S. Pat. Nos. 4,965,122, 4,981,747, 5,114,781, and 5,336,545 to Morman; and U.S. Pat. No. 5,244,482 to Hassenboehler Jr. et al.

“Necked-bonded laminate” refers to a material having an elastomeric film joined to a necked material at least at two places. The elastomeric film may be joined to the necked material at intermittent points or may be completely bonded thereto. The joining is accomplished while the elastic sheet and the necked material are in juxtaposed configuration. The composite elastic necked-bonded material is elastic in a direction generally parallel to the direction of neckdown of the necked material and may be stretched in that direction to the breaking point of the necked material. A necked-bonded laminate may include more than two layers. For example, the elastomeric film may have necked material joined to both of its sides so that a three-layer necked-bonded laminate is formed having a structure of necked material/elastomeric film/necked material. Additional elastomeric films and/or necked material layers may be added. Other combinations of elastomeric films and necked materials may also be used.

“Nonwoven” or “nonwoven web” refers to materials and webs of material having a structure of individual fibers or filaments which are interlaid, but not in an identifiable manner as in a knitted fabric. Nonwoven fabrics or webs have been formed from many processes such as, for example, meltblowing processes, spunbonding processes, air laying processes, coforming processes, and bonded carded web processes. The basis weight of nonwoven fabrics is usually expressed in ounces of material per square yard (osy) or grams per square meter (gsm) and the fiber diameters are usually expressed in microns. (Note that to convert from osy to gsm, multiply osy by 33.91.)

“Peak melting point” refers to the apparent peak temperature at which maximum melting occurs. Peak melting point can be determined with differential scanning calorimetry (DSC). More particularly, peak melting points can be easily assessed and confirmed in DSC thermograms.

“Polymers” include, but are not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and random symmetries.

“Retract” and “retractability” refer to a material's ability to recover a certain amount of its elongation upon release of an applied force.

“Spunbond fiber” refers to small diameter fibers which are formed by extruding molten thermoplastic material as filaments from a plurality of fine capillaries of a spinnerette having a circular or other configuration, with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartmann, U.S. Pat. No. 3,502,538 to Petersen, and U.S. Pat. No. 3,542,615 to Dobo et al., each of which is incorporated herein in its entirety by reference. Spunbond fibers are quenched and generally not tacky when they are deposited onto a collecting surface. Spunbond fibers are generally continuous and often have average deniers larger than about 0.3, more particularly, between about 0.6 and 10.

“Ultrasonic bonding” refers to a process performed, for example, by passing the fabric between a sonic horn and an anvil roll as illustrated in U.S. Pat. No. 4,374,888 to Bornslaeger, incorporated by reference herein in its entirety.

“Vertical filament stretch-bonded laminate” or “VF SBL” refers to a stretch-bonded laminate made using a continuous vertical filament lamination process, as described herein.

These terms may be defined with additional language in the remaining portions of the specification.

### DESCRIPTION OF PREFERRED EMBODIMENTS

The present invention is directed to a soft, elastomeric laminate having a random copolymer facing layer that renders the laminate conducive to ultrasonic bonding, and a method of making such an elastomeric laminate.

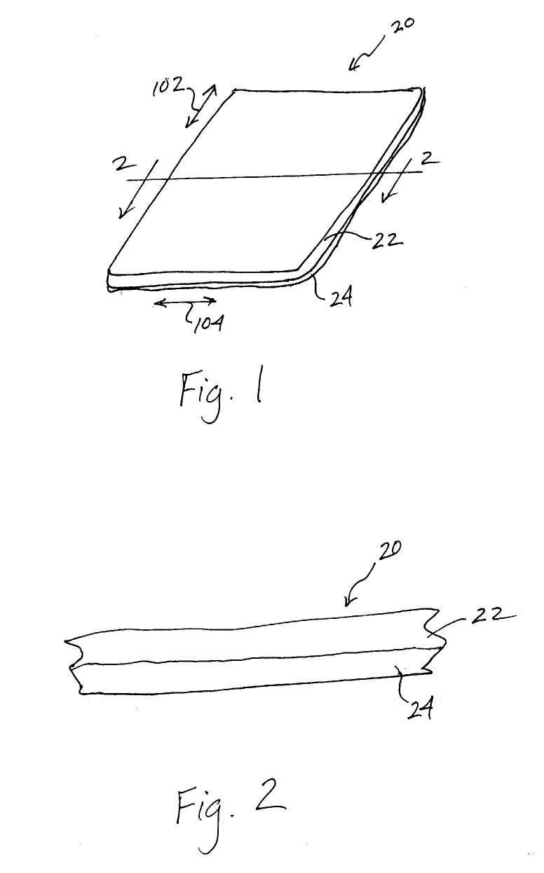

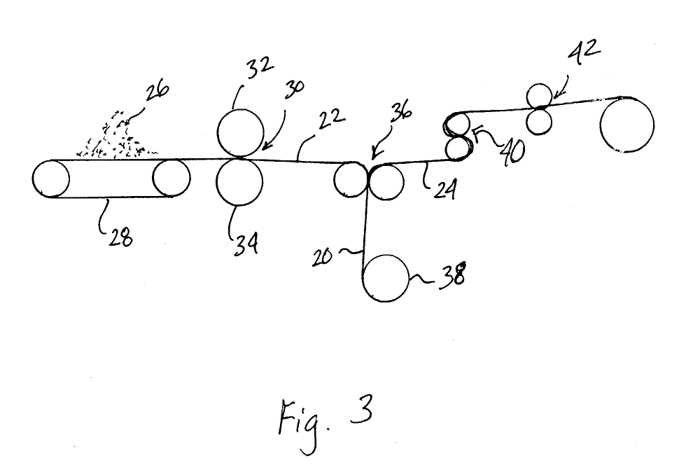

FIG. 1 illustrates an elastomeric laminate 20 of the invention. The elastomeric laminate 20 includes a polymeric nonwoven facing layer 22 laminated to an elastomeric layer 24. Referring to FIG. 1, the elastomeric laminate 20 has a machine direction 102 and a cross-machine direction 104. FIG. 2 illustrates a cross-section of an elastomeric laminate 20 of the invention along line 2-2 of FIG. 1.

The facing layer 22 is designed, through the choice of polymer, basis weight, and bond pattern or bond area, to provide considerable softness and the ability to be ultrasonically bonded at high speeds, namely at least 300 feet per minute (fpm). The facing layer is suitably made Lip of thermoplastic filaments formed from a resin that delivers a relatively low peak melting point and a relatively broad melting curve to create strong individual point bonds and exceptional ultrasonic bonding. More particularly, the thermoplastic filaments may be formed from a random copolymer, or a random copolymer blended with a homopolymer. The copolymer suitably has a peak melting point between about 137 and about 153, or between about 142 and about 153, or between about 145 and about 150 degrees Celsius.

The copolymer from which the facing layer is made may be an ethylene-propylene random copolymer containing from about 0.5 percent to about 10 percent, by weight, ethylene, and from about 99.5 to about 90 percent, by weight, propylene. Alternatively, the olefin copolymer may include polypropylene modified by copolymerizing 0.5-5.0% ethylene randomly in the backbone. As another alternative, the copolymer may be a butylene-propylene random copolymer containing from about 0.5 percent to about 20 percent, by weight, butylene, and from about 99.5 to about 80 percent, by weight, propylene. The random copolymer provides exceptional softness as well as improved bonding capabilities. Typically, softer materials have weaker tear strengths and tensile strengths, but it has been discovered that by incorporating random copolymer into facing materials, the resulting facing materials acquire greater softness without sacrificing bond strength, as evidenced in the examples below. One example of a commercially available random copolymer suitable for making the facing layer is Dow 6D43 random copolymer which includes about 3% ethylene in polypropylene, available from Dow Chemical Company of Midland, Mich. Other suitable random copolymers include SRD 6581 and 6D82, both available from Dow Chemical Company.

In another embodiment, the facing layer may include a blend of a random copolymer and a homopolymer. In this embodiment, the random copolymer may account for between about 10% and about 90%, or between about 20% and about 80%, or between about 24% and about 40% by weight of the facing layer. For example, Dow 6D43 may be blended with standard polypropylene, such as Exxon-Mobil 3445, available from Exxon-Mobil Chemical Company of Baytown, Texas. Other suitable polypropylene homopolymers include Dow 6811, Dow 5D49, Exxon-Mobil 3155, Exxon-Mobil 3854, Basell 308, Basell 304, and BP 7954.

The facing layer is suitably a nonwoven web of fibers, such as, for example, a web of spunbonded fibers, a web of meltblown fibers, a bonded carded web of fibers, a multilayer material including at least one of the webs of spunbonded fibers, meltblown fibers, or a bonded carded web of fibers, such as a spunbond-meltblown-spunbond web, or the like. Other nonwoven materials, such as coform and/or airlaid materials, may also be suitable for use as facing layers. The facing layer suitably has a basis weight of less than about 20 grams per square meter (gsm), or between about 7 and about 20 gsm, or between about 12 and about 20 gsm. The elastomeric layer suitably has a basis weight of less than about 18 gsm, or between about 4 and about 18 gsm, or between about 8 and about 12 gsm. Basis weights disclosed herein are directed to the unretracted state of the material prior to any gathering. The resulting laminate can be stretched by at least 30%, or between about 30 and about 300%, or between about 120% and about 180%.

A bond pattern on the nonwoven facing, resulting from thennal point bonding, further influences the properties of the laminate. Thermal point bonding involves passing a fabric or web of fibers to be bonded between a heated calender roll and an anvil roll. The calender roll is usually, though not always, patterned in some way so that the entire fabric is not bonded across its entire surface. As a result, various patterns for calender rolls have been developed for functional as well as aesthetic reasons. One example of a pattern has points and is the Hansen Pennings or “H&P” pattern with about a 30% bond area with about 200 bonds/square inch as taught in U.S. Pat. No. 3,855,046 to Hansen and Pennings. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5%. Another typical point bonding pattern is the expanded Hansen and Pennings or “EHP” bond pattern which produces a 15% bond area with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15%. Yet another common pattern is the C-Star pattern which has a bond area of about 16.9%. The C-Star pattern has a cross-directional bar or “corduroy” design interrupted by shooting stars. Other common patterns include a diamond pattern with repeating and slightly offset diamonds and a wire weave pattern looking as the name suggests, e.g., like a window screen. The wire weave bond pattern has a bond area between about 14.5% and about 25%. As is well known in the art, the spot bonding holds the laminate layers together as well as imparts integrity to each individual layer by bonding filaments and/or fibers within each layer.

Suitably, the nonwoven facing layer has a bond area of between about 15% and about 34%, or between about 26% and about 31%. Lower cost and higher tension may be achieved through the application of a bond pattern, however softness may be compromised if the bond pattern takes up too much area. For example, the H&P bond pattern delivers lower cost/higher tension than the wire weave bond pattern but is not as soft as the wire weave due to the higher bond area of the H&P.

The elastomeric layer 24 can be made from any suitable elastomeric resins or blends containing the same. For example, materials suitable for use in preparing the elastomeric film include diblock, triblock, tetrablock, or other multi-block elastomeric copolymers such as olefinic copolymers, including styrene-isoprene-styrene, styrene-butadiene-styrene, styrene-ethylene/butylene-styrene, or styrene-ethylene/propylene-styrene, which may be obtained from Kraton Polymers, under the trade designation KRATON elastomeric resin; polyurethanes, including those available from E. I. Du Pont de Nemours Co., under the trade name LYCRA polyurethane; polyamides, including polyether block amides available from Atofina Chemical Company of Philadelphia, Pa., under the trade name PEBAX polyether block amide; polyesters, such as those available from E. I. Du Pont de Nemours Co., under the trade name HYTREL polyester; and single-site or metallocene-catalyzed polyolefins having density less than about 0.89 grams/cubic centimeter, available from Dow Chemical Co. under the trade name AFFINITY. Polymers made using single-site catalysts have a very narrow molecular weight range. Polydispersity numbers (M_{W}/M_{N}) of below 4 and even below 2 are possible for single-site catalyzed polymers. These polymers also have a controlled short chain branching distribution compared to otherwise similar Ziegler-Natta produced type polymers. It is also possible using a single-site catalyst system to control the isotacticity of the polymer quite closely.

A number of block copolymers can be used to prepare the elastomeric layer used in this invention. Such block copolymers generally include an elastomeric midblock portion B and a thermoplastic endblock portion A. The block copolymers may also be thermoplastic in the sense that they can be melted, formed, and resolidified several times with little or no change in physical properties (assuming a minimum of oxidative degradation). Endblock portion A may include a poly(vinylarene), such as polystyrene. Midblock portion B may include a substantially amorphous polyolefin such as polyisoprene, ethylene/propylene polymers, ethylene/butylenes polymers, polybutadiene, and the like, or mixtures thereof.

Suitable block copolymers useful in this invention include at least two substantially polystyrene endblock portions and at least one substantially ethylene/butylene mid-block portion. Commercially available examples of such a linear block copolymers are available from Kraton Polymers under the trade designations KRATON G1657 and KRATON G1730 elastomeric resins. A suitable elastomeric compound is KRATON G2760.

Alternatively, the elastomeric layer can be made of a polymer that is not thermally processable, such as LYCRA spandex, available from E. I. Du Pont de Nemours Co., or cross-linked natural rubber in film or fiber form. Thermoset polymers and polymers such as spandex, unlike the thermoplastic polymers, once cross-linked cannot be thermally processed, but can be obtained on a spool or other form and can be stretched and applied as strands in the same manner as thermoplastic polymers. As another alternative, the elastomeric layer can be made of a single-site catalyzed polymer, such as AFFINITY, available from Dow Chemical Co., that can be processed like a thermoplastic, i.e. stretched and applied, and then treated with radiation, such as electron beam radiation, gamma radiation, or ultraviolet radiation to cross-link the polymer, or use polymers that have functionality built into them such that they can be moisture-cured to cross-link the polymer, thus resulting in a polymer having the enhanced mechanical properties of a thermoset.

The elastomeric layer may also be a multilayer material in that it may include two or more individual coherent webs or films. Additionally, the elastomeric layer may be a multilayer material in which one or more of the layers contain a mixture of elastic and nonelastic fibers or particulates.

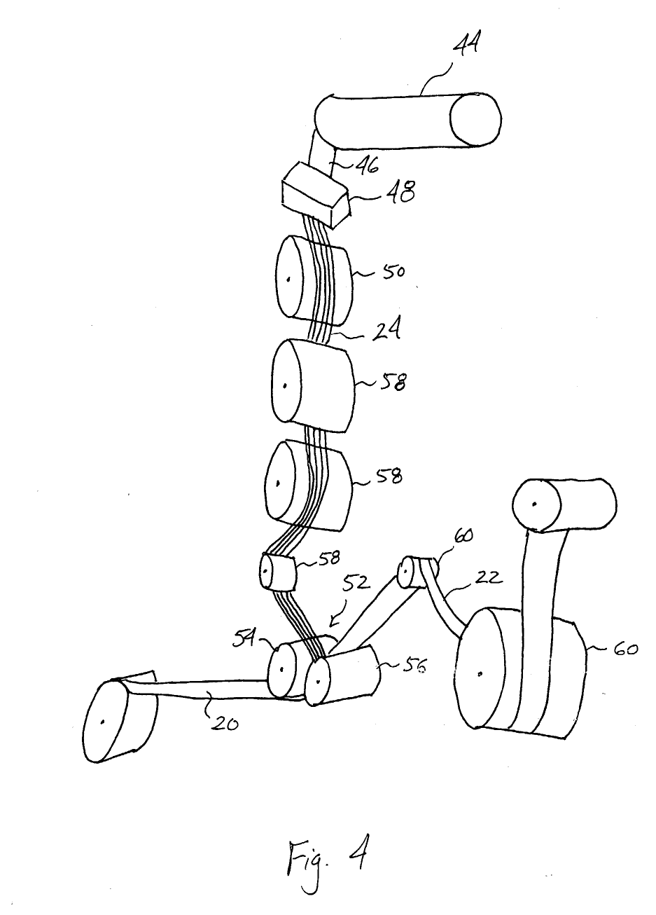

Referring to FIG. 3, there is shown an embodiment of a method of producing the laminate 20. More specifically, as shown, thermoplastic filaments 26, formed from a random copolymer or a random copolymer blend, for example, are randomly deposited onto a forming belt 28 to form the nonwoven facing layer 22, in a manner conventionally used to form nonwoven webs as known to those skilled in the art. As the filaments 26 are deposited on the forming belt 28, a vacuum unit may be positioned under the forming belt to pull the filaments towards the forming belt during the formation of the facing layer 22. As the facing layer 22 is formed, the web is passed through a calender 30, including a calender roller 32 and an anvil roller 34, to bond the filaments 26 for further formation of the web. While the anvil roller 34 is suitably smooth, the calender roller 32 may be smooth or patterned to add a bond pattern to the facing layer, as described above. One or both of the calender roller 32 and the anvil roller 34 may be heated and the pressure between these two rollers may be adjusted by well-known means to provide the desired temperature, if any, and bonding pressure to form the nonwoven facing layer 22. After passing through the calender 30, the facing layer 22 is fed into a laminator 36.

At the laminator 36, pressure is applied to bond the facing layer 22 to a rolled out or extruded elastomeric layer 24 thereby forming the laminate 20 which can be wound up on a wind-up roll 38. Conventional bonding techniques, such as thermal bonding, ultrasonic bonding, and/or adhesive bonding, with either point-bonding or total bonding possible, can be used to bond the elastomeric layer 24 to the facing layer 22. In adhesive bonding, an adhesive such as a hot melt adhesive is applied between the elastomeric layer and the facing layer to bind the layers together. The adhesive can be applied by, for example, melt spraying, printing, coating such as slot coating, or meltblowing. One example of a suitable elastomeric adhesive for adhesively bonding the elastomeric layer to the facing layer is H2096, available from Bostik AtoFindley of Milwaukee, Wis.

Alternatively, the elastomeric layer and the facing material may be autogenously bonded. The term “autogenous bonding” means bonding provided by fusion and/or self-adhesion of fibers and/or filaments without an applied external adhesive or bonding agent. Autogenous bonding may be provided by contact between fibers and/or filaments while at least a portion of the fibers and/or filaments are semi-molten or tacky. Autogenous bonding may also be provided by blending a tackifying resin with the thermoplastic polymers used to form the fibers and/or filaments. Fibers and/or filaments formed from such a blend can be adapted to self-bond with or without the application of pressure and/or heat. Solvents may also be used to cause fusion of fibers and filaments which remains after the solvent is removed.

Suitably, the elastomeric layer 24 may be stretched at least 300% in the process of bonding the elastomeric layer to the nonwoven facing to form a stretch-bonded laminate. Stretch-bonded laminates, and processes for making stretch-bonded laminates, are taught, for example, in U.S. Pat. No. 4,720,415 to Vander Wielen et al. The elastomeric layer can be stretched between two sets of nips 40, 42 with the downstream nip 40 moving faster than the upstream nip 42 to create tension in the elastomeric layer. By adjusting the difference in the speeds of the rollers, the elastomeric layer is tensioned so that it is stretched a desired amount and is maintained in the tensioned, stretched condition as the elastomeric layer is fed into the laminator 36. The laminator may serve as the downstream nip.

Alternatively, or in addition to stretching the elastomeric layer, the facing layer may be necked prior to being bonded to the elastomeric layer. The facing layer may be necked in the same manner that the elastomeric layer is stretched. Consequently, the resulting laminate may be a necked-bonded laminate. If the elastomeric layer is stretched and the facing layer is necked prior to lamination, the resulting necked-bonded laminate would be a multi-direction stretch laminate having stretchability in both the machine direction and the cross-machine direction.

Cross-directional properties of the elastomeric layer can be enhanced by giving the elastomeric layer a cross-directional stretch prior to laminating the elastomeric layer to the facing layer. A cross-directional stretch can be carried out using a tenter frame, grooved rolls, or any other technique known to those skilled in the art. Another suitable method for obtaining a cross-directional stretch of the elastomeric layer is to use a blown film process that would produce a film with inherently better cross-directional properties compared to conventionally extruded films. The improved elastic properties and increased modulus of a blown film allows for a reduction in film basis weight and, consequently, significant cost savings.

The laminating process may be carried out using either a continuous vertical filament or film process or a conventional horizontal lamination process. U.S. patent application Publication Ser. No. 2002-0,104,608, published 08 Aug. 2002, teaches a continuous vertical process while U.S. Pat. No. 5,385,775 to Wright teaches a conventional horizontal lamination process, both of which are hereby incorporated by reference. FIG. 4 illustrates a continuous vertical filament lamination process. An extruder 44 produces reinforcing strands of elastic material 46 through a filament die 48. The strands 46 are fed to a first chill roller 50 and stretched while conveyed vertically towards a nip 52 by one or more first fly rollers 58 (optional) in the strand-producing line. For example, the strands may be stretched between about 300% and about 1000%; alternatively, the strands may be stretched between about 500% and about 800%. In the illustrated process, the elastomeric layer 24 is in the form of multiple elastomeric strands, but the elastomeric layer 24 may be in the form of either strands (array) or film.

The facing layer 22 is conveyed to one or more second fly rollers 60 (optional) towards the nip 52. The facing layer 22 may be necked by the second fly rollers 60 during its passage to the nip 52. The nip 52 is formed by opposing first and second nip rollers 54, 56. The laminate 20 is formed by adhering the strands 24 to the facing layer 22 in the nip 52.

Conventional drive means and other conventional devices which may be utilized in conjunction with the apparatus of FIGS. 3 and 4 are well known and, for purposes of clarity, have not been illustrated in FIGS. 3 and 4.

In another embodiment (not shown), two facing layers are aligned with and bonded to opposite sides of the elastomeric layer. Both of the facing layers are suitably nonwoven layers as described in accordance with the invention, and may either be the same or each web may be different. For example, each web may be made up of the same or different types of filaments, and/or the calender rollers in each nonwoven line can have the same or different types of bond patterns such as one bond pattern that provides greater strength and another bond pattern that provides greater softness.

Because of the polymeric composition of the nonwoven facing layer, the elastomeric laminate is particularly conducive to ultrasonic bonding. The elastomeric laminate (substrate) can be ultrasonically bonded to another substrate, which may be either the same elastomeric laminate material or a different material, at a speed of at least 300 feet per minute, for example. The bond strength of an ultrasonically bonded seam in accordance with the invention is suitably between about 1 kilogram (kg) and about 10 kg, or between about 2 kg and about 8 kg. Bond strength of a seam can be measured using the test method described in detail below.

The elastomeric laminate 20 may be used in a variety of personal care products, including without limitation diapers, training pants, swimwear, absorbent underpants, adult incontinence products, feminine hygiene products, and the like. The elastomeric laminate 100 can also be used in protective garments, including medical garments and industrial protective garments. Medical garments include surgical garments, gowns, aprons, face masks, absorbent drapes, and the like. Industrial protective garments include protective uniforms, workwear, and the like.

The elastomeric laminate 20 of the invention is particularly suitable for use in forming side panels for pant-like absorbent garments, such as training pants. Side seams formed by ultrasonically bonding together two pieces of the elastomeric laminate have exceptional tear strength.

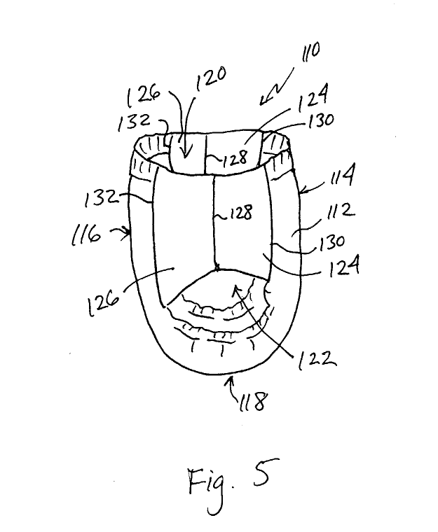

A disposable absorbent pant 110 is illustrated in FIG. 5. The disposable absorbent pant 110 includes a chassis 112 defining a front region 114, a back region 116, and a crotch region 118 interconnecting the front and back regions. The front and back regions 114 and 116 are joined together to define a three-dimensional pant configuration having a waist opening 120 and a pair of leg openings 122. The front region 114 includes the portion of the disposable absorbent pant 110 which, when worn, is positioned on the front of the wearer while the back region 116 includes the portion of the disposable absorbent pant which, when worn, is positioned on the back of the wearer. The crotch region 118 of the disposable absorbent pant 110 includes the portion of the disposable absorbent pant which, when worn, is positioned between the legs of the wearer and covers the lower torso of the wearer.

The chassis 112 also includes a pair of transversely opposed front side panels 124 joined to a pair of transversely opposed back side panels 126. A side seam 128 joining one of the front side panels 124 to one of the back side panels 126 suitably extends from the waist opening 120 to one of the leg openings 122 along opposite sides of the disposable absorbent pant, thereby connecting the front region 114 to the back region 116. With side panels 124, 126 made up of the elastomeric laminate 20 of the invention, the side seam 128 may be formed by ultrasonically bonding the front side panel 124 to the back side panel 126, thereby creating exceptional side panel tear strength despite the high speeds of commercial ultrasonic bonding processes. While a high tear strength is desirable to achieve a secure bond, it is also desirable that the tear strength not be too high, or at least not higher than a tensile strength of the material itself. If a high shear force is applied to a seam, it may be preferable that the seam tear apart before the material itself tears. For example, a garment may be designed such that the seams are intended to be torn as a way of removing the garment. Thus, the bond strength of the seams of this invention, namely between about 1 and about 10 kg, or between about 2 and about 8 kg, is particularly suitable for creating such side seams.

Furthermore, the laminate 20 of the invention also provides exceptional softness without sacrificing seam strength and/or elasticity. Softness generally refers to a surface that yields readily to pressure and is smooth or fine to the touch. Softness can be measured or perceived in a number of ways. As used herein, the term “softness” is a measure of fabric stiffness, and can be determined according to the Cup Crush Test Method described in detail below. More particularly, the facing layer in the laminate of the invention suitably has a softness between about 56 and about 593, or between about 170 and about 426 g-mm.

Front and back side panel seams 130, 132 connecting the respective side panels 124, 126 to the chassis 112 may also be ultrasonically bonded to create exceptional side panel tear strength. Processes of incorporating side panels into a disposable absorbent pant, are known to those skilled in the art, and are described, for example, in U.S. Pat. No. 4,940,464 issued Jul. 10, 1990 to Van Gompel et al., which is incorporated herein by reference.

The exceptional ultrasonic bonding capabilities and fabric softness of the elastomeric laminate of the invention render the laminate suitable for a wide range of uses.

Test Procedure for Measuring Seam Bond Strength

This test is used to test a seam bond strength between two materials, such as two materials in a personal care garment comprising one or more seams. The test is conducted in a standard laboratory atmosphere of 23±2° C. (73.4±3.6° F.) and 50±5% relative humidity. The ultrasonically bonded seams are removed by cutting along the inside edge (for instance, on the absorbent side of a training pant) of the material attachment (where the materials are bonded together) to obtain a 3-inch×3-inch specimen with the seam generally centered. In a training pant, for example, a side panel is attached to the garment along a glue line. The attachment between the materials and the glue line, or other attachment line (if applicable), is marked. These markings are then used to align the specimen in the grips of the tensile tester, each grip having a width of about 3 inches. The specimen is clamped into the grips so that the marked glue lines are aligned with the bottom edge of the top grip and the top edge of the bottom grip. The bond or seam is centered between the grips with the bond facing outwardly from the tensile tester. The material is pulled apart in a T-peel fashion (namely, with the seam forming the stem of the “T” and the side panels forming the top of the “T,” such that the top of the “T” is being pulled in opposite directions at each end) at a crosshead speed of 500±10 mm/min. The tensile tester runs until the specimen ruptures and the peak load bond strength (kg) result is, obtained. A suitable tensile tester can be obtained from Instron Corporation located in Canton, Mass., or from MTS of Eden Prairie, Minn.

Cup Crush Test Method

The softness of a nonwoven fabric may be measured according to the “cup crush” test. The cup crush test evaluates fabric stiffness by measuring the peak load or “cup crush” required for a 4.5 cm diameter hemispherically shaped foot to crush a 25 cm by 25 cm piece of fabric shaped into an approximately 6.5 cm diameter by 6.5 cm tall inverted cup while the cup shaped fabric is surrounded by an approximately 6.5 cm diameter cylinder to maintain a uniform deformation of the cup shaped fabric. An average of 10 readings is used. The foot and the cup are aligned to avoid contact between the cup walls and the foot which could affect the readings. The peak load is measured while the foot is descending at a rate of 40.6 cm/minute and is measured in grams. The cup crush test also yields a value for the total energy required to crush a sample (the “cup crush energy”) which is the energy from the start of the test to the peak load point, i.e. the area under the curve formed by the load in grams on one axis and the distance the foot travels in millimeters on the other. Cup crush energy is therefore reported in g-mm. Lower cup crush values indicate a softer fabric. A suitable device for measuring cup crush is a Sintech Tensile Tester and 500 g load cell using TESTWORKS Software all of which are available from Sintech, Inc. of Research Triangle Park, N.C.

### EXAMPLES

### Example 1

In this example, the bond strengths of laminates having polypropylene facings were compared to the bond strengths of laminates having random copolymer facings.

Each of the laminates was a stretch-bonded laminate including an elastomeric filament layer of KRATON 2760 having a basis weight of about 10 gsm and a filament density of 12 strands per inch. Each of the laminates was made using a vertical filament lamination process, as described with respect to FIG. 4. An adhesive, H2096 available from Bostik-AtoFindley, applied at 2.5 gsm was used to bond a facing sheet to each side of the elastomeric layer. A wire weave thermal bond pattern, creating 24% bond area, was applied to each laminate. Each laminate was ultrasonically bonded at 450 fpm to a second piece of the same laminate to form an ultrasonically bonded seam.

The polypropylene facings were made up of Exxon 3854, available from Exxon-Mobil Chemical Company, formed into a spunbond web. Three different laminates including these facings were tested, each of the three laminates having polypropylene facings of different basis weights, as shown in Table 1.

The random copolymer facings were made up of Dow 6D43, available from Dow Chemical Company, formed into a spunbond web. Three different laminates including these facings were tested, each of the three laminates having random copolymer facings of different basis weights, as shown in Table 2.

Each of the laminates in this example were tested for bond strength in accordance with the Test Procedure for Measuring Seam Bond Strength described above. Each of the facing materials was also tested for softness in accordance with the Cup Crush Test Method described above. Results are shown in Tables 1 and 2. Comparing Tables 1 and 2, it can be seen that the bond strengths of the two types of facings are relatively equal.

However, the random copolymer facings are considerably softer than the polypropylene facings. Thus, it can be concluded that the random copolymer facings provide enhanced softness without sacrificing bond strength.

TABLE 1
Characteristics of Laminates Having Polypropylene Facings

| Basis Weight of Facings | | |
|---|---|---|
| (osy) | Bond Strength (kg) | Softness (g-mm) |
| 0.4 | 4.46 | 382 |
| 0.5 | 4.81 | 665 |
| 0.6 | 4.78 | 856 |

TABLE 2
Characteristics of Laminates Having Random Copolymer Facings

| Basis Weight of Facings | | |
|---|---|---|
| (osy) | Bond Strength (kg) | Softness (g-mm) |
| 0.4 | 4.69 | 170 |
| 0.5 | 4.71 | 337 |
| 0.6 | 4.86 | 426 |

### Example 2

In this example, melt characteristics of three different types of facing materials, in the form of raw material pellets, were tested and compared. The materials tested were Exxon 3155 polypropylene and Exxon 3854 polypropylene, both available from Exxon-Mobil Chemical Company, and Dow 6D43 random copolymer, available from Dow Chemical Company.

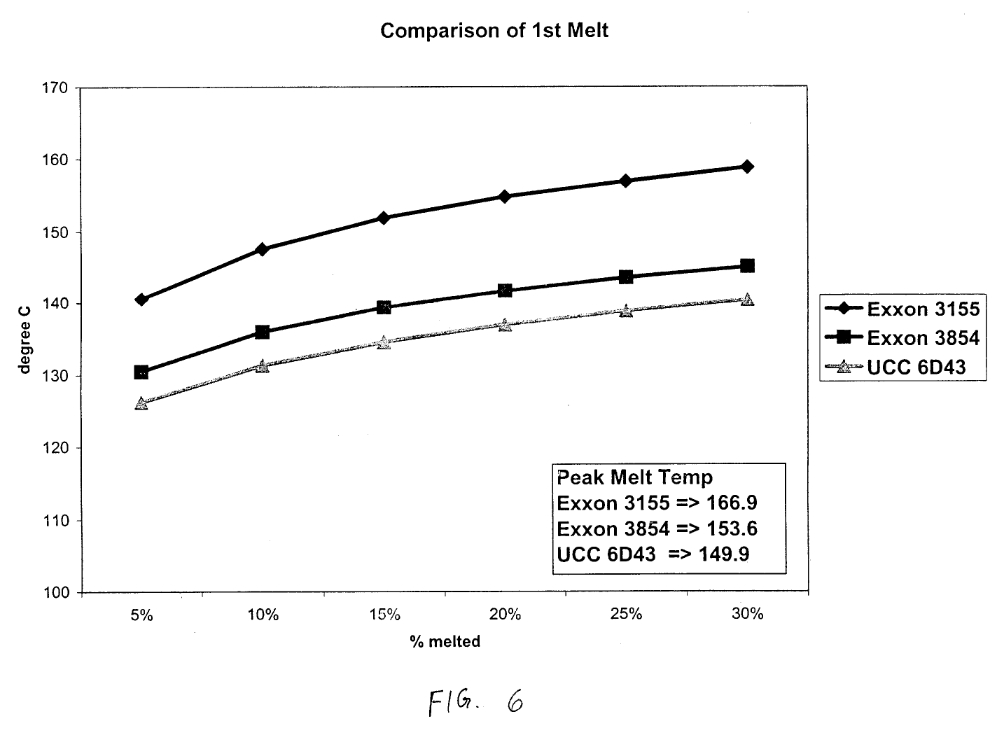

Differential Scanning Calorimetry (DSC) analysis was used to determine the temperatures at which specific percentages of each sample melted, with percentage representing the percentage of the sample melted. The data obtained is shown in Table 3. The temperatures shown in Table 3, in degrees Celsius, are the lowest temperatures at which each percentage of the melting occurred. The data in Table 3 is graphically represented in FIG. 6.

TABLE 3
Melt Characteristics of Facing Materials

| | Temp. | Temp. | Temp. | Temp. | Temp. | Temp. |
|---|---|---|---|---|---|---|
| Material | at 5% | at 10% | at 15% | at 20% | at 25% | at 30% |
| Exxon 3155 | 140.6 | 147.6 | 151.9 | 154.8 | 156.9 | 158.8 |
| Exxon 3854 | 130.5 | 135.9 | 139.3 | 141.7 | 143.6 | 145.1 |
| Dow 6D43 | 126.2 | 131.3 | 134.5 | 136.9 | 138.8 | 140.4 |

The peak melt temperatures of the materials in Table 3 were determined during the same DSC analysis and are shown in Table 4.

TABLE 4
Peak Melt Temperatures of Facing Materials

| Material | Peak Melt Temp. (° C.) |
|---|---|
| Exxon 3155 | 166.9 |
| Exxon 3854 | 153.6 |
| Dow 6D43 | 149.9 |

As can be seen in Tables 3 and 4, the random copolymer melts at lower temperatures than either of the polypropylene homopolymers throughout a full range of melt percentages. Thus, laminates having random copolymer facings require less dwell time in ultrasonic bonding processes for a bond to form because the random copolymer melts more readily at lower temperatures than polypropylene homopolymers. Consequently, laminates having random copolymer facings are particularly suitable for use in high speed ultrasonic bonding processes.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

What is claimed is:

1. An elastomeric laminate, comprising:
at least one nonwoven web facing layer including thermoplastic filaments formed from a random copolymer, the at least one facing layer laminated to an elastomeric layer.

2. The elastomeric laminate of claim 1, wherein the random copolymer comprises an ethylene-propylene random copolymer.

3. The elastomeric laminate of claim 2, wherein the random copolymer contains from about 0.5 percent to about 10 percent, by weight, ethylene, and from about 99.5 to about 90 percent, by weight, propylene.

4. The elastomeric laminate of claim 1, wherein the random copolymer comprises a butylene-propylene random copolymer.

5. The elastomeric laminate of claim 4, wherein the random copolymer contains from about 0.5 percent to about 20 percent, by weight, butylene, and from about 99.5 to about 80 percent, by weight, propylene.

6. The elastomeric laminate of claim 1, wherein the random copolymer has a peak melting point between about 137 and about 153 degrees Celsius.

7. The elastomeric laminate of claim 1, wherein the random copolymer has a peak melting point between about 142 and about 153 degrees Celsius.

8. The elastomeric laminate of claim 1, wherein the random copolymer has a peak melting point between about 145 and about 150 degrees Celsius.

9. The elastomeric laminate of claim 1, wherein the nonwoven web facing layer comprises nonwoven selected from the group consisting of a web of spunbonded fibers, a web of meltblown fibers, a bonded carded web of fibers, a multi-layer material including at least one of the webs of spunbonded fibers, meltblown fibers, and a bonded carded web of fibers.

10. The elastomeric laminate of claim 1, wherein the thermoplastic filaments in the at least one facing layer comprise a blend of random copolymer and a homopolymer.

11. The elastomeric laminate of claim 10, wherein the thermoplastic filaments comprise between about 10% and about 90% by weight random copolymer.

12. The elastomeric laminate of claim 10, wherein the thermoplastic filaments comprise between about 20% and about 80% by weight random copolymer.

13. The elastomeric laminate of claim 10, wherein the thermoplastic filaments comprise between about 24% and about 40% by weight random copolymer.

14. The elastomeric laminate of claim 1, wherein the at least one nonwoven web facing layer has a bond area of between about 15% and about 34%.

15. The elastomeric laminate of claim 1, wherein the at least one nonwoven web facing layer is adhesively laminated to the elastomeric layer.

16. The elastomeric laminate of claim 1, wherein the at least one nonwoven web facing layer is autogenously laminated to the elastomeric layer.

17. The elastomeric laminate of claim 1, wherein the at least one nonwoven web facing layer has a basis weight of less than about 20 grams per square meter.

18. The elastomeric laminate of claim 1, wherein the at least one nonwoven web facing layer has a basis weight of between about 7 and about 20 grams per square meter.

19. The elastomeric laminate of claim 1, wherein the at least one nonwoven web facing layer has a basis weight of between about 12 and about 20 grams per square meter.

20. The elastomeric laminate of claim 1, wherein the elastomeric layer has a basis weight of less than about 18 grams per square meter.

21. The elastomeric laminate of claim 1, wherein the elastomeric layer has a basis weight of between about 4 and about 18 grams per square meter.

22. The elastomeric laminate of claim 1, wherein the elastomeric layer has a basis weight of between about 8 and about 12 grams per square meter.

23. The elastomeric laminate of claim 1, wherein the laminate can be stretched by at least about 30%.

24. The elastomeric laminate of claim 1, wherein the laminate can be stretched between about 30% and about 300%.

25. The elastomeric laminate of claim 1, wherein the laminate can be stretched between about 120% and about 180%.

26. The elastomeric laminate of claim 1, comprising a stretch-bonded laminate.

27. The elastomeric laminate of claim 1, comprising a necked-bonded laminate.

28. An ultrasonically bonded seam, comprising:
a first substrate including at least one nonwoven web facing layer including thermoplastic filaments formed from a random copolymer, the at least one nonwoven web facing layer having a basis weight of less than about 20 grams per square meter laminated to an elastomeric layer having a basis weight of less than about 18 grams per square meter; and
a second substrate ultrasonically bonded to the first substrate.

29. The ultrasonically bonded seam of claim 28, wherein the seam has a bond strength of about 1 kilogram to about 10 kilograms.

30. The ultrasonically bonded seam of claim 28, wherein the seam has a bond strength of about 2 kilograms to about 8 kilograms.

31. The ultrasonically bonded seam of claim 28, wherein the random copolymer comprises an ethylene-propylene random copolymer.

32. The ultrasonically bonded seam of claim 28, wherein the random copolymer comprises a butylene-propylene random copolymer.

33. The ultrasonically bonded seam of claim 28, wherein the random copolymer has a peak melting point between about 137 and about 153 degrees Celsius.

34. The ultrasonically bonded seam of claim 28, wherein the at least one nonwoven web facing layer comprises nonwoven selected from the group consisting of a web of spunbonded fibers, a web of meltblown fibers, a bonded carded web of fibers, a multi-layer material including at least one of the webs of spunbonded fibers, meltblown fibers, and a bonded carded web of fibers.

35. The ultrasonically bonded seam of claim 28, wherein the thermoplastic filaments in the at least one nonwoven web facing layer comprise a blend of random copolymer and a homopolymer.

36. The ultrasonically bonded seam of claim 35, wherein the thermoplastic filaments comprise between about 10% and about 90% by weight random copolymer.

37. The ultrasonically bonded seam of claim 28, wherein the at least one nonwoven web facing layer has a bond area of between about 15% and about 34%.

38. The ultrasonically bonded seam of claim 28, wherein the at least one nonwoven web facing layer is adhesively laminated to the elastomeric layer.

39. The ultrasonically bonded seam of claim 28, wherein the at least one nonwoven web facing layer is autogenously laminated to the elastomeric layer.

40. The ultrasonically bonded seam of claim 28, wherein the at least one nonwoven web facing layer has a basis weight of between about 7 and about 20 grams per square meter.

41. The ultrasonically bonded seam of claim 28, wherein the at least one nonwoven web facing layer has a basis weight of between about 12 and about 20 grams per square meter.

42. The ultrasonically bonded seam of claim 28, wherein the elastomeric layer has a basis weight of between about 4 and about 18 grams per square meter.

43. The ultrasonically bonded seam of claim 28, wherein the elastomeric layer has a basis weight of between about 8 and about 12 grams per square meter.

44. The ultrasonically bonded seam of claim 28, wherein the first substrate comprises a stretch-bonded laminate.

45. The ultrasonically bonded seam of claim 28, wherein the first substrate comprises a necked-bonded laminate.

46. The ultrasonically bonded seam of claim 28, wherein the second substrate comprises at least one nonwoven web facing layer including thermoplastic filaments formed from a random copolymer, the at least one nonwoven web facing layer having a basis weight of less than about 20 grams per square meter laminated to an elastomeric layer having a basis weight of less than about 18 grams per square meter.

47. An absorbent garment comprising a pair of side panels, each of the side panels including the ultrasonically bonded seam of claim 28.

48. A method of bonding an elastomeric laminate, comprising:
providing an elastomeric laminate having at least one random copolymer nonwoven facing; and
ultrasonically bonding the elastomeric laminate to a substrate.

49. The method of claim 48, wherein the ultrasonic bonding can be carried out at a speed of at least 300 feet per minute.

50. The method of claim 48, further comprising making the elastomeric laminate by bonding the at least one random copolymer nonwoven facing to an elastomeric layer while stretching the elastomeric layer at least 300%, wherein the at least one random copolymer nonwoven facing has a basis weight of less than about 20 grams per square meter and the elastomeric layer has a basis weight of less than about 18 grams per square meter.

51. The method of claim 50, further comprising necking the nonwoven facing prior to bonding the nonwoven facing to the elastomeric layer.

52. The method of claim 48, wherein the at least one random copolymer nonwoven facing comprises a random copolymer having a peak melting point between about 137 and about 153 degrees Celsius.

53. The method of claim 52, wherein the at least one random copolymer nonwoven facing comprises an ethylene-propylene random copolymer.

54. The method of claim 48, wherein the at least one random copolymer nonwoven facing comprises a butylene-propylene random copolymer.

55. The method of claim 48, wherein the at least one random copolymer nonwoven facing comprises a blend of random copolymer and a homopolymer.

56. The method of claim 48, wherein the substrate comprises an elastomeric laminate having at least one random copolymer nonwoven facing.
